(19) United States
(12) Patent Application Publication
(10) Pub. No.: US 2008/0284121 A1
(43) Pub. Date: Nov. 20, 2008

(54) All-Terrain Board

(76) Inventor: George French, Sheffield (GB)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/571,847

(22) PCT Filed: Sep. 8, 2004
(86) PCT No.: PCT/GB2004/003865

§ 371 Date: Aug. 8, 2008

(30) Foreign Application Priority Data
Sep. 15, 2003 (GB) 0321556.3

(51) Int. Cl. B62M 1/00

(52) U.S. Cl. 280/87.042

(57) ABSTRACT

An all-terrain board has a platform which is supported on two wheel axles connected to the platform by pairs of flexible links. The links in each pair are spaced on either side of a longitudinal axis of the platform. The links are biased so that they have a horizontal dimension when the platform is loaded with a rider. When the rider tilts the platform, this shortens the horizontal dimension on the tilted side, and lengthens it on the other, so that a steering effect is created. The biased links also provide the board's suspension.

The invention relates to all terrain skateboards, or all terrain boards, as they are commonly known. The fundamental difference between all-terrain boards and normal skateboards is the provision of large wheels, larger than 100 mm in diameter, to accommodate variable surface terrain. In particular, all-terrain boards are suited for grass or sand surfaces, which are either too rough or too soft for skateboard wheels of less than 100 mm diameter. Also, all-terrain boards need suspension to take up bumps in surfaces such as normally found on grassy slopes. Wheels also usually have soft and wide treaded tyres. However, it is wheel diameter which is the most important distinction.

All such boards generally have two or more wheels, typically four, and a standing board for the rider. They are ridden on a variety of types of terrain in the same way as a skateboard or snowboard. They are also often used in conjunction with a kite, sail, motor or other propulsion device. Existing four-wheel designs are largely based upon a pair of rigid axles linking adjacent wheels. These axles are then each constrained to a fixed steering axis perpendicular to the axle and at an angle relative to the main plane of board, which board is parallel the ground when the board is sitting normally on the ground on all it wheels. This axis provides a means by which the board may rock from side to side and in so doing provide a steering action to both pairs of wheels relative to the board and each other. A spring return is normally provided to keep the steering in a neutral position. By moving his or her weight from side to side, a rider is therefore able to steer the board and maintain his or her balance on it.

Other designs use the rocking of the board on horizontal pivots to actuate linkages to individual wheel hubs which are held in their own individual mounting pivots and steer in a similar manner to traditional car steering systems.

Such devices are common and there exist many design variations, however they suffer from a number of problems. Since all-terrain boards are, by definition, used on rough ground, some form of suspension is essential, but is difficult and complex to provide. A common solution is to make use of the standing board by rendering it flexible. However, with such an arrangement, upon landing, such as after a jump or other manoeuvre, the riders weight must be precisely aligned over the centre of the standing board to maintain a straight course. A slight misalignment of the rider's weight can energise the steering, which might result in a sharp turn and the rider being thrown off.

Stresses in such arrangements are concentrated in the steering pivot area. Axles must be able to support a relatively long bending arm. Strength is therefore required. However, since boards must often be carried up hill by the user, their weight is an important factor, and should be minimised, whereas the above problems tend to increase the resultant weight of the board. A heavy board is also disadvantageous when performing tricks and jumps, or making sudden course corrections.

Wear and play within the steering axis is also a disadvantage and can lead to a condition known as “speed wobble” in which the rider experiences a loss of straight line stability.

Existing designs are also relatively complex and expensive to manufacture.

The object of this invention is to provide an all-terrain board that addresses, or at least mitigates, these problems and is, ideally, more stable, has good suspension, is light weight and simple to produce.

According to the present invention there is provided an all-terrain board comprising:

a platform, defining a plane which, in use, is substantially parallel the ground, a longitudinal axis in said plane extending from a front end to a rear end of the platform;

a front and rear axle, adjacent each end of the platform, at least one being a steering axle;

a wheel, rotationally journalled at each end of the or each steering axle;

a combined suspension/steering element, joining the platform with the or each steering axle; and

bias means that bias each element to a position, when the board is on horizontal ground and unloaded, in which said platform plane and the or each steering axle are substantially parallel, the or each steering axle is substantially perpendicular with said longitudinal axis, and said link has a horizontal dimension,

wherein both suspension and steering of the board are integrated in said element, whereby, on the one hand, vertical loading of the platform results in deflection of the element and compression of said bias means, and, on the other hand, tilting of the platform about its longitudinal axis, when the platform is under a vertical load, results in rotation of the element with at least a component of said rotation being about a vertical axis through said steering axle to effect a steering moment on said steering axle.

By “horizontal dimension” is meant that the connections between the platform and steering axle or axles are not vertically aligned but are horizontally spaced, either to some extent, or to the maximum extent permitted by the element. Preferably, when unloaded, said horizontal dimension approaches the maximum extent permitted by the element.

Preferably, the front and rear axles are each steering axles, each having a said combined suspension/steering element connecting it to the platform at each end thereof. If, however, only one is, the other has one or more wheels to support that end of the board.

Preferably, the or each of said combined suspension/steering element comprises a pair of links, one link of the pair being on either side of said longitudinal axis and spaced therefrom. In this event, different suspension movements of said links result in said rotation and steering movement of the steering axle.

The effect of this arrangement is that, when the weight of a rider is evenly distributed on the board, the bias means permit deflection of the links by the same degree, so that the platform remains horizontal. Preferably, when loaded with the weight of a rider for whom the board is intended, said links maintain a horizontal dimension.

Moreover, when the weight of the rider is tilted to one side of the longitudinal axis, the links on that side are deflected further than on the other side, whose loading is at least partially relaxed. The horizontal dimension is therefore reduced on the side of the board which is downwardly tilted, compared with the other side. This inclines the wheel axles so that they steer in the direction of downward tilt of the platform.

Accordingly, the present invention produces the required steering effect and suspension within the same mechanism. By linking the axles to the standing platform by links which are able to pivot or flex against a restoring bias they create a combined steering axis and suspension travel. Indeed, increased suspension movement on one side relative to the other creates the required steering effect.

Preferably, the steering axle is cantilevered from the end of the platform on the links, which deflect under the rider's weight. The angle of deflection creates a backward and forward motion of the front and rear wheels relative to one another. This acts to steer the device when the deflection is uneven across the platform. Under heavy loads such as landing a jump, the suspension may be fully loaded, thus minimising the steering effect of any imbalance in the rider's weight distribution. That is to say, under greater load than merely the rider's weight, said horizontal dimension is eliminated, or at least reduced to a minimum that the links can permit.

Preferably, one or more of said links is a flexible leaf element fixed at each end to the axle and platform. Indeed, a single leaf element, provided it has substantial width spanning said longitudinal axis, may connect each axle to the platform. In this case, on tilting of the platform, one edge of the leaf element goes into tension, while the other edge is compressed, or at least not tensioned as much as the one edge.

Alternatively, there may be more than one pair of flexible leaf elements joining the platform to the or each steering axle.

Each leaf element may comprise an elongate body, an eye, at one end of the body, to receive the steering axle, and an attachment region at the other end of the body for connection to the platform. The attachment region may comprise a pair of bores each to receive a bolt passing through the bores of, and joining, adjacent leaf elements, and clamp means to connect to the board.

Spacers may be disposed between the eyes of adjacent leaf elements to spread the connection of the elements from the longitudinal axis. This has the effect of increasing the steering effect without changing significantly the suspension of the platform.

Alternatively, the links may be rigid and pivoted to the platform. A spring biases each rigid link to a position in which it is, preferably, horizontal, at least under no load. Preferably, the platform is horizontal when it is under a minimum load, being less than the load of the weight of the smallest rider for whom the board is intended. The pivot permits pivoting about an axis perpendicular to said longitudinal axis, and also, at least to a limited extent, about an axis lying parallel said longitudinal axis.

In a further alternative, the combined suspension/steering element is a single flexible rod or tube disposed in a vertical plane containing said longitudinal axis and rigidly fixed centrally of both the or each steering axle and the or each end of the platform. Under no-load conditions, the rod may substantially be coaxial with said longitudinal axis. When the platform is vertically loaded, the rod may be deflected against its own resilience to adopt an inclined connection to the steering axle with respect to the longitudinal axis, whereupon rotation of the rod caused by tilting of the board about said longitudinal axis effects a component of rotation of the steering axle about a vertical axis.

Embodiments of the invention are described below, by way of example, with reference to the accompanying drawings, in which:

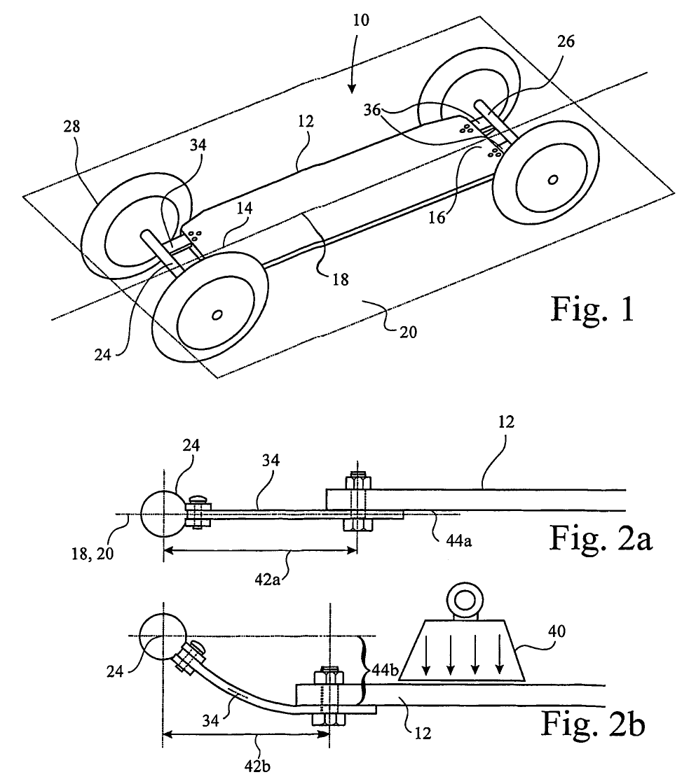

FIG. 1 is a perspective view of a first embodiment in accordance with the present invention;

FIGS. 2a and b are side views of the front of the board of FIG. 1 unloaded and loaded respectively;

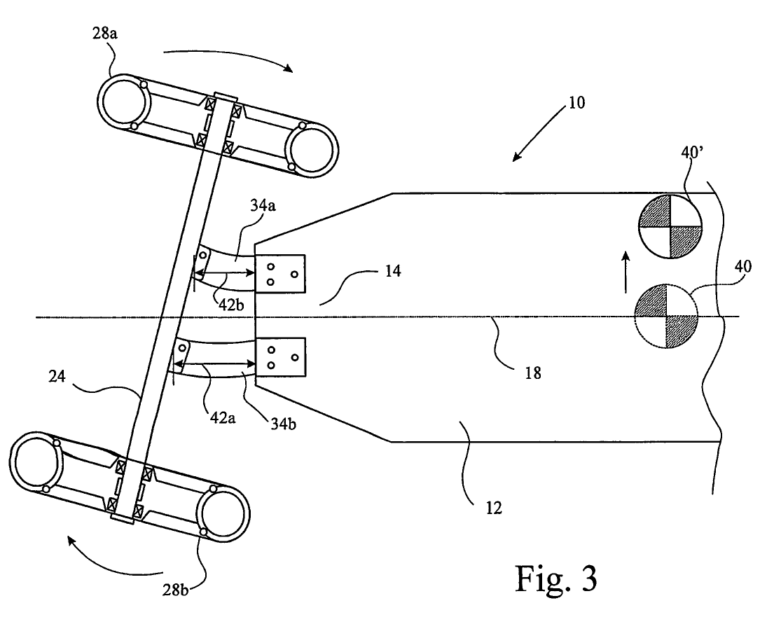

FIG. 3 is a plan view of the board of FIG. 1 loaded off a longitudinal axis of the platform;

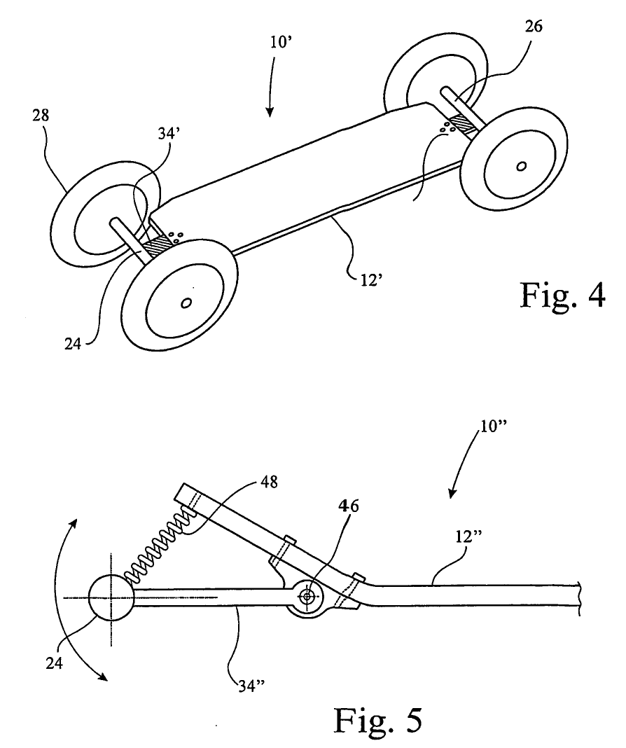

FIG. 4 is a perspective view of an alternative embodiment in accordance with the present invention;

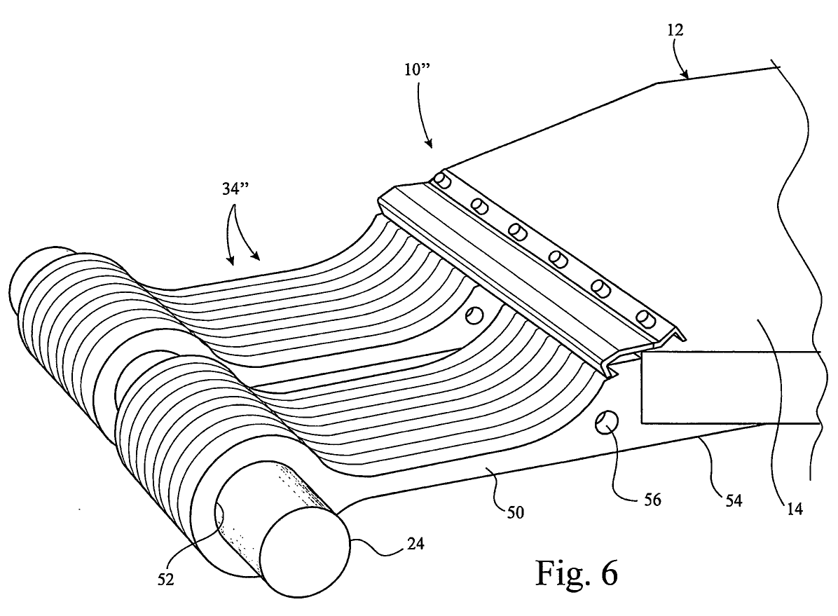

FIG. 5 is a side view of another alternative embodiment in accordance with the present invention;

FIG. 6 is a perspective view of a steering axle and platform end of another alternative embodiment of the present invention;

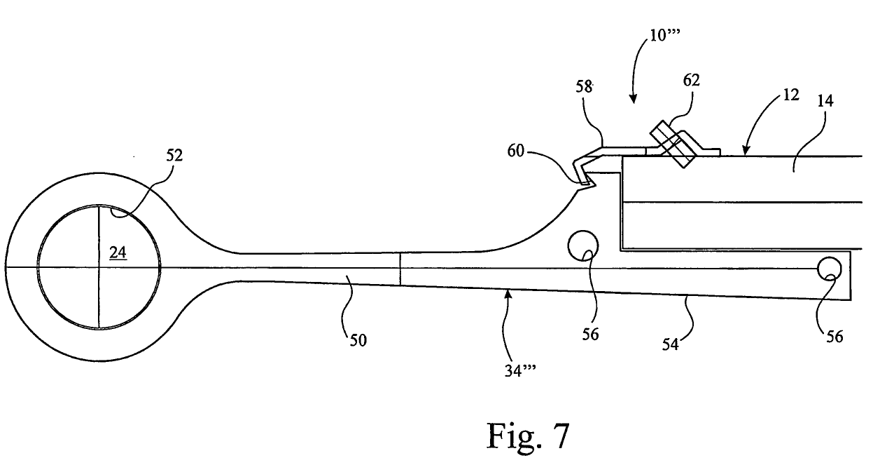

FIG. 7 is side view of the embodiment of FIG. 6; and,

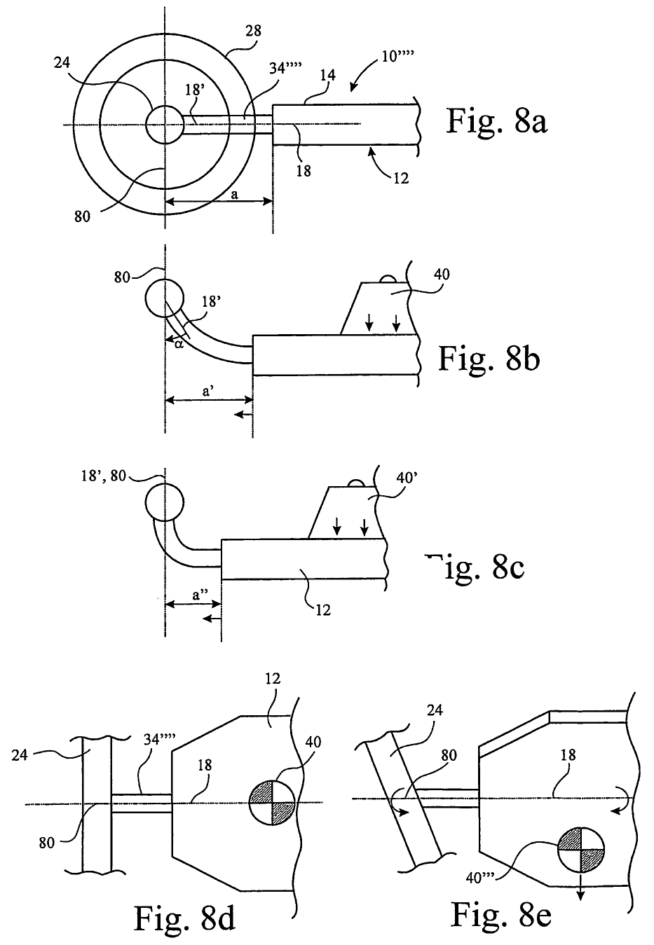

FIGS. 8a to e are, respectively, in different states of loading, three side views and two plan views of a further embodiment of a board in accordance with the present invention.

In the drawings, an all-terrain skateboard 10 has a platform 12 having a front end 14 and rear end 16. A longitudinal axis 18 is defined by the platform which lies in a plane 20 parallel the longitudinal axis 18.

An axle 24,26 is attached to each end of the platform. Each axle lies substantially in the plane 20 under no load conditions. Each axle 24,26 mounts a wheel 28 at each end so that, when placed on flat, horizontal ground, the platform 12, and hence the longitudinal axis and plane 20, are parallel the ground. A pair of flexible leaf elements 34,36 connects the axles to the platform 12. Each leaf element in each pair is disposed one on either side of the longitudinal axis 18. Each pair constitutes a single combined suspension/steering element, and each axle 24,26 is a steering axle.

Referring to FIG. 2a, the platform 12 is slightly above the axle 24, the leaf elements 34 being sufficiently rigid, and the platform 12 being sufficiently light, that the leaf elements 34 have a substantially horizontal orientation. However, when a weight 40 is placed on the platform 12 (se FIG. 2b), the leaf elements 34 deflect so that the platform 12 sinks below the level of the axle 24. As a result, the axles 24,26 move closer together. However, the leaf element 34 has sufficient resilience so that, a) the platform 12 does not contact the ground (not shown), and b) a residual horizontal dimension remains between the platform and the axle 24. The horizontal dimension may also be referred to as the overhang 42a,b as shown in FIGS. 2a and b. The leaf elements therefore constitute a suspension arrangement for the board 10.

Turning to FIG. 3, the load 40 from FIG. 2b has been shifted laterally with respect to the longitudinal axis 18 to position 40′. The effect of this transfer of loading is to increase the tension on the right hand leaf element 34a and relieve the tension, to a certain extent, on the left hand leaf element 34b. The effect of these changes in tension is to increase the vertical deflection 44b on the right hand side, which correspondingly reduces the overhang 42b on that side. Conversely, the vertical separation 44 between the platform and axle 24 on the left hand side is reduced, possibly to zero as shown in FIG. 2a. This has the effect of increasing the horizontal overhang 42a. The effect of these combined horizontal overhangs is that there is rotation of the axle 24 about a vertical axis, so that a steering action is imparted to the wheel 28a,b. The leaf elements therefore constitute a steering arrangement for the board 10.

An identical situation pertains at the rear wheels so that, by tilting the platform to the right hand side, the wheels turn the board 10 to the right, and vice-versa. However, it may be desired to steer only the front wheels, for example. In this event, the connection to the rear axle is conventional, with or without suspension. Nevertheless, the connection must permit rotation of the platform about its longitudinal axis 18. In this event, the most convenient arrangement might be a single, centrally disposed rear wheel that tilts when the platform tilts about its longitudinal axis.

At the same time, the leaf elements 34, being resilient and biased towards a raised position of the platform 12 with respect to the ground, provides suspension for the board 10. Accordingly, the board can be ridden with reasonable comfort even over relatively rough ground.

The arrangement provides a further advantage in that, on completing a jump where maximum loading is imparted onto the platform 12, the overhang in respect of both leaf elements is minimised. Very little turning effect is therefore created at the precise moment of landing. This is good because it is on landing a jump that a rider is usually most unstable. It is only once the weight of the rider has been absorbed by the board and the resilience of the leaf elements 34 have returned the platform to a position in which some horizontal overhang 42 has been restored that the steering capability is restored. On the other hand, by this time, the rider should have regained some measure of control so that any corrective steering required can be effected.

Turning to FIG. 4, the pair of leaf elements 34a,b have here been replaced by a single leaf element 34′ in the board 10′. The provision of two separate leaf elements 34 is by no means essential and a single leaf element is quite sufficient provided it has sufficient spread in the direction of the axles 24, 26 to effect the steering function described above with reference to FIG. 3.

FIG. 5 shows a further embodiment in which each leaf element has been replaced a rigid link 34″ fixed on the axle 24. Here the axle is split to permit different rotations of the links 34 with respect to the axis of the axle 24. Alternatively, it may have sufficient torsional flexibility to accommodate different rotations of the links 34″.

The links 34″ are pivoted about bearings 46 to the platform 12″. These bearings primarily permit rotation about an axis perpendicular to the longitudinal axis 18 and parallel the plane 20, but also permit some rotation about an axis lying parallel the longitudinal axis 18. A spring 48 biases the link 34″ towards a horizontal position in which the overhang is at a maximum.

The deformation of each spring is proportional to the weight applied to it. As the rider moves his or her weight to one side, the springs on that side deform more and so shorten the wheel-spacing on that side. As this happens, the opposite side springs are relieved of some of their load. They relax slightly, thus lengthening the wheel base on that side. Since the wheels are linked in pairs by rigid axles this creates an angular displacement of the axles relative to the board in opposing directions, thus creating a steering effect.

Referring now to FIGS. 6 and 7, here, a board 10″′, being a different embodiment of the present invention, employs a multitude of individual leaf elements 34″′ arranged in an array across the front 14 and, optionally, the rear (not shown), of the platform 12. Each element 34″′ has a body 50, an eye 52 at one end of the body, and a connection region 54 at the other end. The eye is sized to receive the axle 24. The connection region has two bores 56 adapted to receive bolts (not shown) that clamp the array together. Indeed, a plate (not shown) may be connected to the array by the bolts so that the array can be fixed to the underside of the platform 12. A top plate 58 is shown which clamps on a hook 60 formed on the elements 34″′ and which is fixed to the top of the platform 12 by screws schematically illustrated at 62.

The advantage of this arrangement over the embodiments of FIGS. 1 to 4 is that complex twisting loads on the leaf elements is largely eradicated. Instead, each leaf element primarily only has bending and tensile loads in vertical planes parallel the longitudinal axis 18 to contend with. Moreover, the arrangement provides for much easier customisation of the board 10″′ to suit different rider preferences. Firstly, individual leaf elements can be given different bending and tensile characteristics. Secondly, spacers can be inserted between adjacent eyes 52 on the axle 24. This permits adjustment of the steering effect without changing the suspension ride of the board.

While the array of leaf elements is shown in two groups in FIG. 6, this is not mandatory and they could be across the entire end of the platform 12. Indeed, central ones will have primarily a suspension role in the array, whereas it is the outside ones that have more of a steering role in the array.

In all the embodiments, adjustments can be made for varying rider weights or styles of riding by various means. These would include, but not be limited to: shortening and lengthening spring overhangs; replacing spring units with ones of different stiffness; moving springs in and out relative to the centre line of the platform; adding or removing extra spring elements; or changing the pressure of gas springs and other preloaded spring element adjustments.

Finally, referring to FIGS. 8a to e, a further embodiment of the present invention is illustrated. Here, a board 10″″ has a single central flexible rod 34″″ fixed at each end to the platform 14 and axle 24.

Unloaded, as in FIG. 8a, the rod 34″″ is coaxial with the longitudinal axis 18 of the board. Under some loading 40, the board is deflected vertically downwardly, resulting in some rearward movement of the wheels 28 relative to the platform shortening the horizontal dimension a to a′. Further loading 40′ has a further impact on the horizontal dimension a″ which is further shortened.

In FIG. 8a, the axis 18′ of the rod 34″″ where it joins the axle 24 is substantially perpendicular a vertical axis 80 passing through the axle 24. However, the angle a between those axes diminish as the board is loaded until they are substantially coincident in the FIG. 8c position.

Rotation of the platform about its longitudinal axis 18 in the FIG. 8a position of the platform 12 has no steering effect: it merely results in twisting of the rod 34″″, whereby a certain vertical loading is imposed on one of the wheels 28. However, in the FIGS. 8b and c positions, when the load 40,40′ is shifted laterally of the longitudinal axis by a rider changing his/her position on the platform 12, the twisting of the rod 34″″ develops at a component that is about the axis 80. Consequently, under those loaded conditions the rod 34″″ transmits a steering action as shown in FIG. 8e, as well as suspending the platform 12 on the wheels 28. Consequently, the rod 34″″ constitutes a combined suspension/steering element.

While deflections of the rod 34″″ are shown between extremes of horizontal (FIG. 8a) in its connection to the axle 24 to vertical (FIG. 8c), in practice, such a full range may not be practical. The reason for this is that the torsional stiffness of the rod 34″″ is difficult to separate from its bending stiffness. It is possibly unlikely, therefore, that the loading range that takes the board between the positions shown in FIGS. 8a to c will result in the rod having sufficient torsional stiffness. Such stiffness is required both to effect the required steering rotation in proportion to board tilt, and to resist aberrant steering effects caused by wheel impacts or the like. Consequently an intermediate position is likely to be selected, as a person skilled in the art may decide gives the best results.

1. An all-terrain board comprising:
a platform, defining a plane which, in use, is substantially parallel the ground, a longitudinal axis in said plane extending from a front end to a rear end of the platform;
a front and rear axle, adjacent each end of the platform, at least one being a steering axle;
a wheel, rotationally journalled at each end of the or each steering axle;
a combined suspension/steering element, joining the platform with the or each steering axle; and
bias means that bias each element to a position, when the board is on horizontal ground and unloaded, wherein said platform plane and the or each steering axle are substantially parallel, the or each steering axle is substantially perpendicular with said longitudinal axis, and said link has a horizontal dimension, as herein defined,
wherein both suspension and steering of the board are integrated in said element, whereby, on the one hand, vertical loading of the platform results in deflection of the element and compression of said bias means, and, on the other hand, tilting of the platform about its longitudinal axis, when the platform is under a vertical load, results in rotation of the element with at least a component of said rotation being about a vertical axis through said steering axle to effect a steering moment on said steering axle.

2. A board according to claim 1, wherein the front and rear axles are each steering axles, each having a said combined suspension/steering element connecting it to the platform at each end thereof.

3. A board according to claim 1, wherein the or each said combined suspension/steering element comprises a pair of links, one link of the pair being on either side of said longitudinal axis and spaced therefrom.

4. A board according to claim 3, wherein, when unloaded, said horizontal dimension approaches the maximum extent permitted by the links.

5. A board according to claim 2, wherein, when the weight of a rider is evenly distributed on the platform, the bias means each permit deflection of the links by the same degree, so that the platform remains horizontal.

6. A board according to claim 3, wherein, when loaded with the weight of a rider for whom the board is intended, said links maintain a horizontal dimension.

7. A board according to claim 1, wherein said bias means constitutes the only suspension arrangement for the board.

8. A board according to claim 1, wherein the or each steering axle is cantilevered from the end of the platform.

9. A board according to claim 1, wherein, under loads which fully load the suspension, the steering effect of any imbalance in the riders weight distribution is minimised in that said horizontal dimension is eliminated or reduced to a minimum that the combined suspension/steering element permits.

10. A board according to claim 3, wherein one or more of said links comprises a flexible leaf element fixed at each end to the axle and platform.

11. A board according to claim 10, wherein said pair of links comprises a single one of said leaf element, which element has substantial width spanning said longitudinal axis and connecting each axle to the platform, wherein, on tilting of the platform, one edge of the leaf element goes into tension, while the other edge is compressed, or at least not tensioned as much as said one edge.

12. A board according to claim 10, wherein said pair of links comprises a plurality of said leaf elements joining the platform to the or each steering axle.

13. A board according to claim 12, wherein each leaf element comprises an elongate body, an eye, at one end of the body, to receive the steering axle, and an attachment region at the other end of the body for connection to the platform.

14. A board according to claim 13, wherein the attachment region comprises a pair of bores each to receive a bolt passing through the bores of, and joining, adjacent leaf elements, and clamp means to connect to the board.

15. A board according to claim 13, wherein spacers are disposed between the eyes of adjacent leaf elements to spread the connection of the elements from the longitudinal axis.

16. A board as claimed claim 3 wherein said links comprise rigid links pivoted to the platform, a spring biasing the rigid link to a position wherein it has a horizontal dimension, said pivot permitting pivoting of the link with respect to the platform about an axis parallel said platform plane and perpendicular said longitudinal axis, and also about an axis lying parallel said longitudinal axis.

17. A board according to claim 16, wherein, under a minimum load being less than the load of the weight of the smallest rider for whom the board is intended, said spring biases the rigid link to a position wherein it has a maximum horizontal dimension.

18. A board according to claim 1, wherein said combined suspension/steering element is a single flexible rod or tube disposed in a vertical plane containing said longitudinal axis and rigidly fixed centrally of both the or each steering axle and the or each end of the platform.

19. A board according to claim 18, wherein, under no-load conditions, the rod is substantially coaxial with said longitudinal axis.

20. A board according to claim 18, wherein, when the platform is vertically loaded, the rod is deflected against its own resilience to adopt an inclined connection to the steering axle with respect to the longitudinal axis, whereupon rotation of the rod caused by tilting of the board about said longitudinal axis effects a component of rotation of the steering axle about a vertical axis.

21. An all-terrain board comprising:
a platform, defining a plane which, in use, is substantially parallel the ground, a longitudinal axis in said plane extending from a front end to a rear end of the platform;
a front and rear axle, adjacent each end of the platform, at least one being a steering axle;
a wheel, rotationally journalled at each end of the or each steering axle;
a combined suspension/steering element, joining the platform with the or each steering axle; and
bias means that bias each element to a position, when the board is on horizontal ground and unloaded, wherein said platform plane and the or each steering axle are substantially parallel, the or each steering axle is substantially perpendicular with said longitudinal axis, and said link has a horizontal dimension, as herein defined,
wherein both suspension and steering of the board are integrated in said element, whereby, on the one hand, vertical loading of the platform results in deflection of the element and compression of said bias means, and, on the other hand, tilting of the platform about its longitudinal axis, when the platform is under a vertical load, results in rotation of the element with at least a component of said rotation being about a vertical axis through said steering axle to effect a steering moment on said steering axle; and
wherein the or each said combined suspension/steering element comprises a pair of links, one link of the pair being on either side of said longitudinal axis and spaced therefrom.

22. An all-terrain board comprising:
a platform, defining a plane which, in use, is substantially parallel the ground, a longitudinal axis in said plane extending from a front end to a rear end of the platform;
a front and rear axle, adjacent each end of the platform, at least one being a steering axle;
a wheel, rotationally journalled at each end of the or each steering axle;
a combined suspension/steering element, joining the platform with the or each steering axle; and
bias means that bias each element to a position, when the board is on horizontal ground and unloaded, wherein said platform plane and the or each steering axle are substantially parallel, the or each steering axle is substantially perpendicular with said longitudinal axis, and said link has a horizontal dimension, as herein defined,
wherein both suspension and steering of the board are integrated in said element, whereby, on the one hand, vertical loading of the platform results in deflection of the element and compression of said bias means, and, on the other hand, tilting of the platform about its longitudinal axis, when the platform is under a vertical load, results in rotation of the element with at least a component of said rotation being about a vertical axis through said steering axle to effect a steering moment on said steering axle; and
wherein said combined suspension/steering element comprises a single leaf element, which element has substantial width spanning said longitudinal axis and connecting the or each axle to the platform, wherein, on tilting of the platform, one edge of the leaf element goes into tension, while the other edge is compressed, or at least not tensioned as much as said one edge.
